(19) United States
(12) Patent Application Publication
(10) Pub. No.: US 2006/0229748 A1
(43) Pub. Date: Oct. 12, 2006

(54) Method and apparatus for dynamic comparison of data sets

(76) Inventors: Richard W.I. Yarger, Berkeley, IL (US); Vijayanand Tirumalai N.C., Kenosha, WI (US)

Correspondence Address: MCANDREWS HELD & MALLOY, LTD, 500 WEST MADISON STREET, SUITE 3400, CHICAGO, IL, 60661, US

(21) Appl. No.: 11/103,146

(22) Filed: Apr. 11, 2005

(51) Int. Cl. G05B 15/00; G06K 9/00

(52) U.S. Cl. 700/83; 382/100

(57) ABSTRACT

Static display protocols for comparing a plurality of data sets are complex and inefficient. A system and method for a dynamic display protocol is disclosed. A user may compare a plurality of data sets using a dynamic display protocol for controlling the display of a plurality of data sets. In an embodiment, the dynamic display protocol utilizes two binary input sequences to control the display of the data sets. The first input sequence maintains the data set displayed on at least one first predetermined display region and shifts the data set displayed on at least one second predetermined display region. The second input sequence shifts the data set displayed on a plurality of display regions. In an embodiment, the first input sequence is controlled by the “up” and “down” arrow keys and the second input sequence is controlled by the “right” and “left” arrow keys on a computer keyboard.

### BACKGROUND OF THE INVENTION

The present invention generally relates to a system and method for dynamically comparing time-based information. Particularly, the present invention relates to a system and method for dynamically comparing a plurality of time-based medical images of a patient.

Medical diagnostic imaging systems encompass a variety of imaging modalities, such as x-ray systems, computerized tomography (CT) systems, ultrasound systems, electron beam tomography (EBT) systems, magnetic resonance (MR) systems, and the like. Medical diagnostic imaging systems generate images of an object, such as a patient, for example, through exposure to an energy source, such as x-rays passing through a patient, for example. The generated images may be used for many purposes. For instance, internal defects in an object may be detected. Additionally, changes in internal structure or alignment may be determined. Fluid flow within an object may also be represented. Furthermore, the image may show the presence or absence of objects in an object. The information gained from medical diagnostic imaging has applications in many fields, including medicine and manufacturing.

An example of a medical diagnostic imaging system is a Picture Archival Communication System (PACS). PACS is a term for equipment and software that permits information and images, such as x-rays, ultrasound, CT, MRI, EBT, MR, or nuclear medicine for example, to be electronically acquired, stored and transmitted for viewing. Images from an exam may be viewed immediately, stored, or transmitted. The images may be viewed on diagnostic workstations by users, for example radiologists. In addition to viewing the images, the user may also view patient and/or study information associated with the image or study.

Typically, a patient may have more than one exam in which medical images are acquired. When a radiologist is reading a patient's exam, the radiologist often may compare the current exam to similar exams that the patient has had in the past. For example, monitoring the growth or remission of a tumor may involve acquiring a series of images over a period of time. A radiologist may compare the images from a current exam with images from a previous, or historical exam, to analyze the effectiveness of treatment or status of the disease. The radiologist may also compare the images from consecutive historical exams to monitor the status of the tumor over a period of time.

For example, a radiologist may compare the current exam with the most recent previous exam, or the first historical exam, which, may be an exam conducted one week ago. The radiologist may also compare the current exam with the next most recent previous exam, or the second historical exam, which may have been conducted two weeks ago. In another example, a radiologist may compare consecutive exams. A radiologist may compare a current exam with the next most recent previous exam, or first historical, which may have been conducted one week ago. The radiologist may also compare the exam from one week ago, the first historical, with an exam from two weeks ago, the second historical.

Current display protocols for comparing images, however, are difficult and awkward to use. The current display protocols are static, meaning the display protocols generally must be pre-programmed to support the varying number of historical exams that each patient may have had. These static display protocols are complex and difficult to monitor across the possible exam procedures. Moreover, from the point of view of a user, the static display protocols are inefficient and time consuming.

Accordingly, there is a need for a system and method for displaying time-based information using a dynamic display protocol. Such a system and method may allow a user to compare data sets dynamically and efficiently.

### SUMMARY OF THE INVENTION

Certain embodiments of the present invention include a system for dynamically comparing time-based information. The system comprises a computer unit for manipulating data and receiving input from a user. The computer unit executes computer software for a dynamic display protocol for controlling the display of a plurality of data sets. The system also includes at least one display unit having a plurality of display regions for displaying the data sets. The dynamic display protocol includes a first input sequence. The first input sequence may be a binary sequence to maintain the data set displayed on at least one first predetermined display region and shift the data set displayed on at least one second predetermined display region.

The computer unit may receive input from a user for controlling the first input sequence from a computer keyboard. The first input sequence may be executed by using the “up” and “down” arrow keys on the computer keyboard. After the execution of the first input sequence, the data set displayed on at least one first predetermined display region is maintained and the data set displayed on at least one second predetermined display region is either the next least recent data set in time or the next most recent data set in time, depending on the binary command issued by the user.

The dynamic display protocol also includes a second input sequence. The second input sequence may be a binary sequence to shift the data set displayed on a plurality of display regions. The computer unit may also receive input from a user controlling the second input sequence from a computer keyboard. The second input sequence may be executed by the “right” and “left” arrow keys on the computer keyboard. After the execution of the second input sequence, the data sets displayed on the plurality of display regions are either the next least recent data set in time or the next most recent data set in time, depending on the binary command issued by a user.

In an embodiment, the data sets may depict medical images. Moreover, the computer unit may also receive input from a user controlling a computer mouse or a track ball.

Certain embodiments of the present invention include a method for dynamically comparing time-based information. The method comprises optionally executing a first input command for shifting at least one data set displayed and maintaining at least one data set displayed. The shifted data set displayed being shifted to the next least recent data set in time. The method also comprises optionally executing a second input command for shifting at least one data set displayed and maintaining at least one data set displayed. The shifted data set displayed being shifted to the next most recent data set in time. The method also comprises optionally executing a third input command for shifting a plurality of data sets displayed. The plurality of shifted data sets displayed being shifted to the next least recent data sets in time. The method also includes optionally executing a fourth input command for shifting a plurality of data sets displayed. The plurality of shifted data sets displayed being shifted to the next most recent data sets in time.

In the method described above, the steps of optionally executing a first, second, third, or fourth input command are executed on a computer keyboard. The first input command may be executed by pressing the down arrow on the computer keyboard. The second input command may be executed by pressing the up arrow on the computer keyboard. The third input command may be executed by pressing the right arrow on the computer keyboard. The fourth input command may be executed by pressing the left arrow on the computer keyboard. Additionally, the data sets may depict medical images.

Certain embodiments of the present invention include a computer-readable storage medium including a set of instructions for a computer. The set of instructions comprise a first optional input routine for optionally executing a first input command for shifting at least one data set displayed and maintaining at least one data set displayed. The shifted data set displayed being shifted to the next least recent data set in time. A second optional input routine for optionally executing a second input command for shifting at least one data set displayed and maintaining at least one data set displayed. The shifted data set displayed being shifted to the next most recent data set in time. A third optional input routine for optionally executing a third input command for shifting a plurality of data sets displayed. The plurality of shifted data sets displayed being shifted to the next least recent data sets in time. A fourth optional input routine for optionally executing a fourth input command for shifting a plurality of data sets displayed. The plurality of shifted data sets displayed being shifted to the next most recent data sets in time.

In the set of instructions described above, the first, second, third, or fourth optional input routine are executed on a computer keyboard. The first optional input routine may be executed by pressing the down arrow on the computer keyboard. The second optional input routine may be executed by pressing the up arrow on the computer keyboard. The third optional input routine may be executed by pressing the right arrow on the computer keyboard. The fourth optional input routine may be executed by pressing the left arrow on the computer keyboard. Additionally, the data sets may depict medical images.

### BRIEF DESCRIPTION OF THE DRAWINGS

FIG. 1 illustrates an example of a system that may be used in accordance with an embodiment of the present invention for displaying time-based information.

FIG. 2 illustrates a data map with reference to FIG. 1, displaying a current exam and a first historical exam.

FIG. 3 illustrates a data map with reference to FIG. 1, displaying a current exam and a second historical exam.

FIG. 4 illustrates a data map with reference to FIG. 1, displaying a first historical exam and a third historical exam.

FIG. 5 illustrates a data map with reference to FIG. 1, displaying a first historical exam and a second historical exam.

FIG. 6 illustrates a data map with reference to FIG. 1, displaying a current exam and a first historical exam.

FIG. 7 illustrates a method for dynamically comparing time-based information.

### DETAILED DESCRIPTION OF THE INVENTION

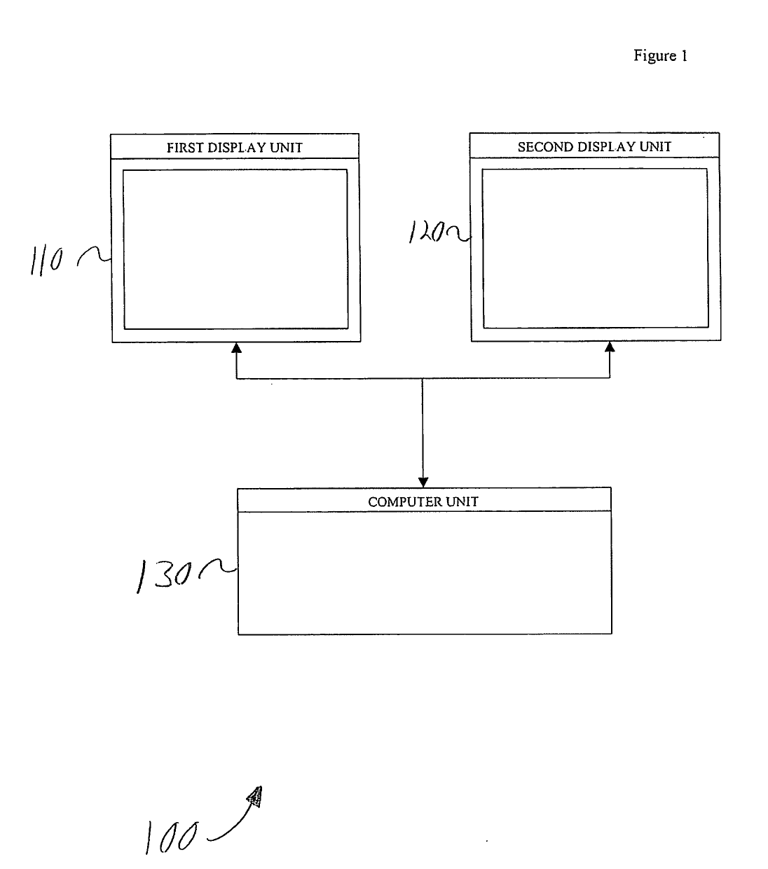

FIG. 1 illustrates a system 100. The system 100 is example of a system that may be used in accordance with an embodiment of the present invention. As an example, the system 100 shows two display units, unit 110 and unit 120. The display units 110 and 120 may be computer monitors or other display devices. As the system 100 is only an example, more or less display units may be used with the system 100. As shown, display units 110 and 120 include a single display region. However, the display units may have more than one display region. Accordingly, the invention may be realized with any number of display units and any number of display regions, including a single display unit with multiple display regions.

Also included in the system 100 is a computer unit 130. The computer unit 130 may be any equipment or software that receives input information from a user and formulates electronic data for display. Although illustrated as a single box, the equipment or software composing computer unit 130 may be a plurality of devices and software typically associated with a computer unit. For example, the computer unit 130 may comprise various input devices, network connections, and connections to external equipment such as a database.

The system 100 may also comprise any equipment and/or software permitting a plurality of electronic information to be displayed and compared. For example, the computer unit 130 may be a computer such as a personal computer having a keyboard and mouse as input devices. In such an example, the computer unit 130 may display data sets depicting documents. A current version of a particular document may be displayed on the first display unit 110 and an earlier, or historical version of the document may be displayed on the second display unit 120. As another example, the computer unit 130 may display data sets depicting waveforms. A current version of a particular waveform may be displayed on the first display unit 110 and an earlier, or historical version of the waveform may be displayed on the second display unit 120. As a user is able to display time-based information, a user may compare a data set from one time period to a data set from another time period.

In another example, the computer unit 130 may be, or may be part of, a picture archival communication system (PACS), or other system that permits electronic medical information and images, such as x-rays, ultrasound, CT, MRI, EBT, MR, or nuclear medicine for example, to be electronically acquired, stored, or transmitted for viewing and operation. In such an example, the computer unit 130 may represent equipment that may be generally associated with PACS, including input controls, communication processing, and storage equipment. The input controls may comprise a standard keyboard computer mouse, buttons, or track ball. In such an example, the computer unit 130 may display data sets depicting medical images and/or information about a patient on display units 110 and 120.

The computer unit 130 may also be connected to other devices as part of an electronic network. For example, the computer unit 130 may be connected to a data base for retrieval of information, an intranet for local communication or the Internet for global communication. The components of the system 100 may be single units, separate units, may be integrated in various forms, and may be implemented in hardware and/or in software.

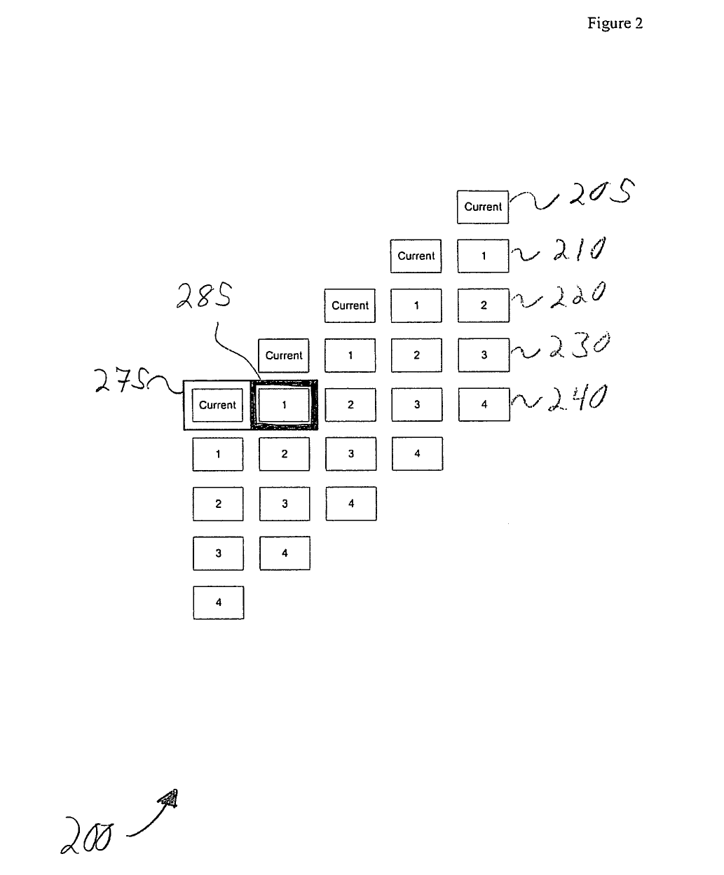

As FIG. 1 is just an example, a greater number or lesser number of display units may be used in accordance with the present invention, including a single display unit. FIGS. 2-6 are discussed with reference to FIG. 1 as an example of an embodiment of the present invention. Any hanging protocol may be used, however, and any combination of images or data sets may be displayed in accordance with the present invention. The FIGS. 2-6 are discussed as an example of the system 100 being a PACS system and the display units 110 and 120 displaying images of a patient. However, in accordance with the present invention, the data sets may be any type of time-based information.

The FIGS. 2-6 illustrates a data map. The data map comprises five data sets of time-based information. For example, the current data set 205 is the most recent chronological data set. The data set “1” 210 is the next most recent chronological data set. The data set “2” 220 is the next most recent chronological data set. The data set “3” 230 is the next most recent chronological data set. Finally, the data set “4” 240 is the next most recent chronological data set. Although the data map illustrates five data sets, any number of data sets can be used in accordance with the present invention.

Additionally in the data maps of FIGS. 2-6, each box that is labeled similarly represents the same data set. For example, the boxes labeled “current” all represent a current data set 205. The boxes labeled “1” all represent data set “1” 210. The boxes labeled “2” all represent data set “2” 220. The boxes labeled “3” all represent data set “3” 230. Finally, the boxes labeled “4” all represent data set “4” 240. As an example, the boxes of the data maps of FIGS. 2-6 may represent data sets of examinations of a patient. The current data set 205 may be the most recent examination, as a function of time, of the patient. The other data sets (sets 1-4) may be historical data sets, meaning that the examinations are not the most recent, as a function of time. In this example, the data sets 210-240 may be referred to as historical data sets 1-4, respectively.

Also shown in FIGS. 2-6 are a first box 275 and a second box 285 that surround the data sets 205-240. As detailed in the example provided in FIGS. 2-6, the first box 275 represents the image displayed on display unit 110. The second box 285 represents the image displayed on the display unit 120. The boxes may also represent display regions in an embodiment with a single display unit or an embodiment where more than one data set is displayed on a display unit. Accordingly, the use of two boxes is just an example, and the number of boxes may increase as the number of display units increase or the number of display regions increase.

FIGS. 2-6 illustrate an embodiment of the invention for executing a dynamic display protocol for controlling the display of a plurality of data sets. As mentioned above, a user may wish to compare a plurality of data sets. In the embodiment of the data sets as medical images, a user may wish to compare a current exam with a plurality of historical exams. A user may also wish to compare consecutive chronological images, such as in a trend study. In accordance with the present invention, a user may dynamically compare any current exam, or data set, with any available historical exam or data set. A user may also dynamically compare any available historical exam, or data set, with any other available historical exam, or data set.

In the embodiment of FIGS. 2-6, a user utilizes two input sequences to control the dynamic display protocol and dynamic navigation through the data sets. In an embodiment, the input sequences may be executed using the four arrow keys on a computer keyboard. The first input sequence may be controlled using the “up” and “down” arrow keys on a computer keyboard. In the example of the system 100, pressing the “up” or “down” arrow keys may shift the exam displayed in the second display unit 120. In terms of the data maps, the box 285 shifts up or down with respect to the “up” or “down” arrow keys. The second input sequence may be controlled using the “right” or “left” arrows on the keyboard. Pressing the “right” or “left” keys on the computer keyboard shifts both the exams displayed in the first display unit 110 and the second display unit 120. In terms of the data maps, both the boxes 275 and 285 shift right or left with respect to the “right” or “left” arrow keys. Although the two input sequences are described as being input into a computer using arrow keys on a computer keyboard, other techniques or devices may be used. For example, a user may press other keys on the keyboard, utilize a computer mouse, buttons, or a trackball to input commands.

In an embodiment, a user may use the four arrow keys on a standard keyboard to control the navigation through the available current and historical data sets. In general, a user may use the up or down arrow keys to shift the display of the display box 285 up or down in the data map, and thus shift what is displayed on display unit 120. A user may use the right and left arrow keys to shift both the first box 275 and the second box 285 right or left in the data map, thus changing the display of both display units 110 and 120.

In operation, the system 200 shows the first box 275 displaying the current exam on display unit 110 and the second box displaying the first historical exam “1” 210 on display unit 120. In the embodiment having two display units or display regions, the display protocol of the system 200 may be displayed upon opening a patient's file.

In the system 300, a user has pushed the “down” arrow key, or equivalent, and has shifted the second display box 285 down in the data map. Notice that, as the “up” and “down” arrow keys control only the box 285, only the box 285 has shifted down. The display unit 120 now displays the second most historical exam “2” 220. Accordingly, a user may now compare the current exam of display box 275 displayed on display unit 110 and the next least recent exam, which is the second most historical exam “2” 220, is displayed on display unit 120. If a user were to push the down key again, the next least recent exam, which is the third most historical exam “3” 230, would be displayed in display unit 120. Again, as the “up” and “down” arrow keys control only the box 285, only the box 285 would shift. In such a manner, a user may compare a current exam with any historical exam.

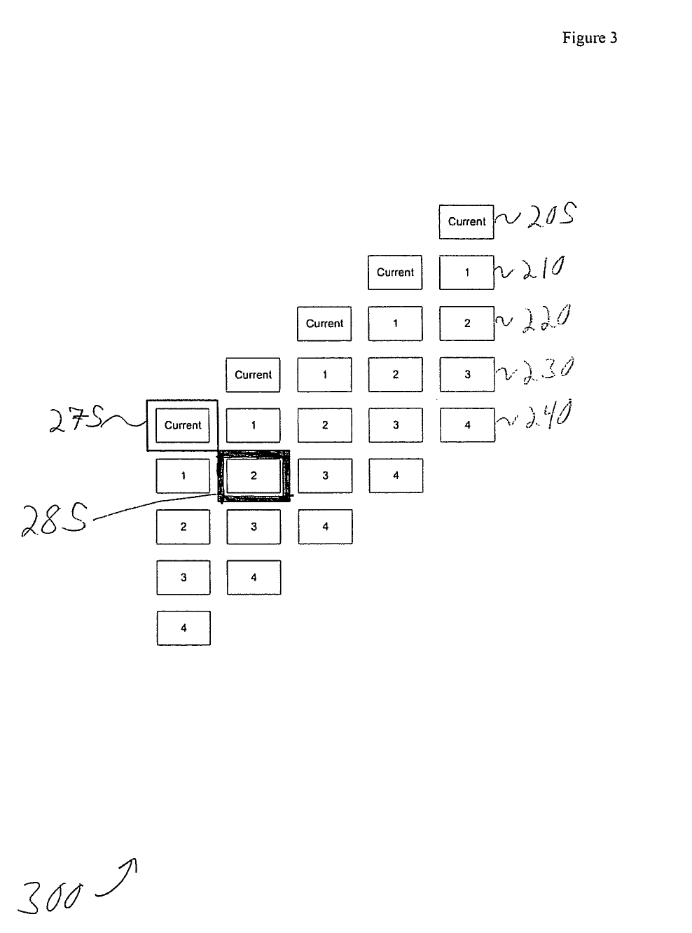

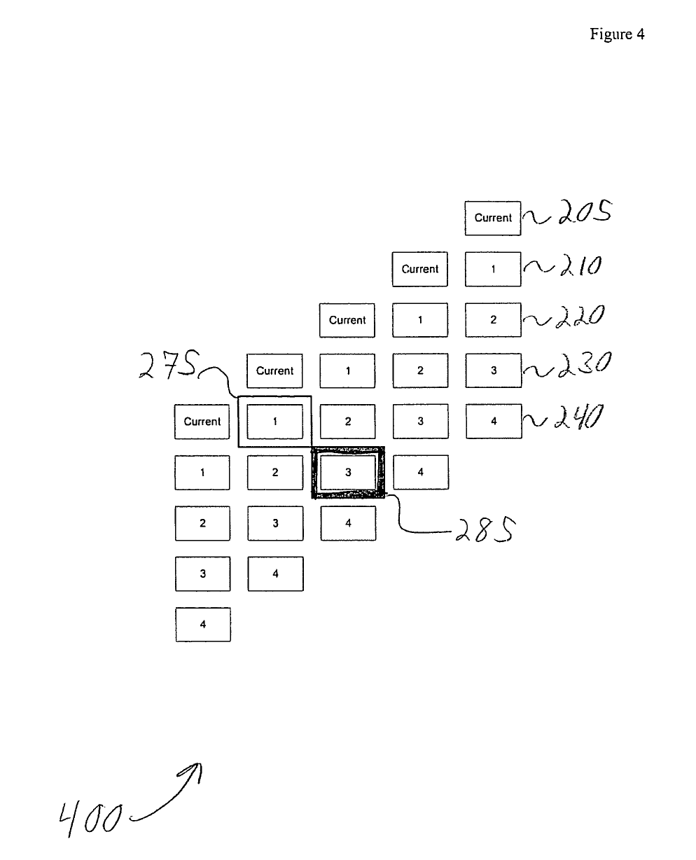

In FIG. 4, a user having the images displayed on units 110 and 120 of FIG. 3 as the current exam on display unit 110 and the second historical on display unit 120, has pushed the “right” arrow key. Notice that as the “right” and “left” arrow keys control both box 275 and 285, both box 275 and box 285 have shifted to the right. Pressing the “right” arrow key shifts the data sets to display the next least recent, or next most historical data sets, in time. After pressing the “right” arrow key, box 275 now displays the first historical image “1” 210 and box 285 now displays the third historical image “3” 230. Accordingly, the first historical image “1” 210 is displayed in display unit 110 and the third historical image “3” 230 is displayed in display unit 120.

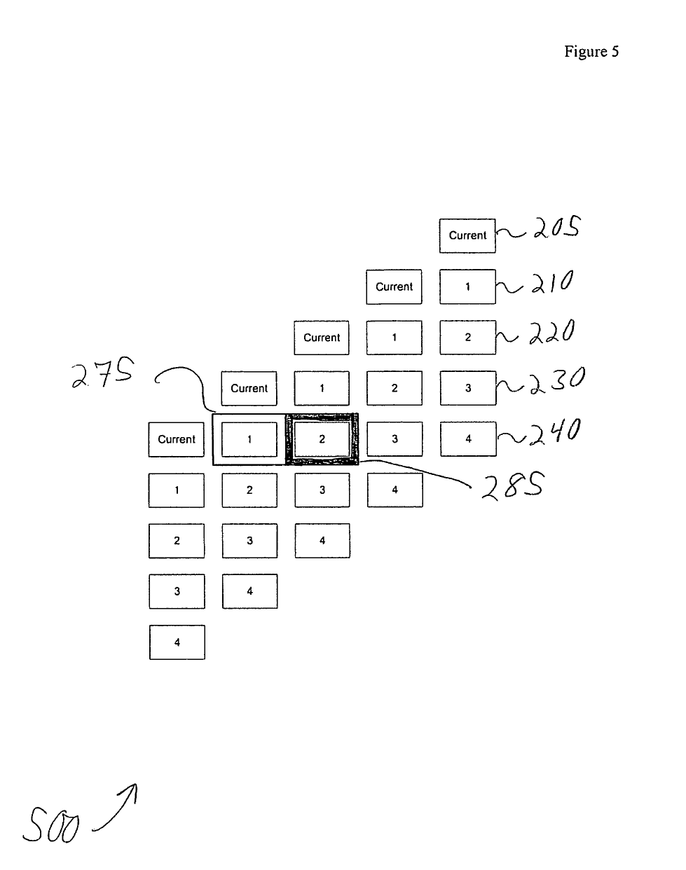

In FIG. 5, a user having the images displayed on units 110 and 120 of FIG. 4 as the current exam on display unit 110 and the third historical exam on display unit 120, a user has pressed the “up” button on the keyboard. Notice that as the “up” and “dow” arrow keys control only box 285, only box 285 has shifted up. Pressing the “up” arrow key shifts the data sets to display the next most recent, or next least historical data sets, in time. Accordingly, as the up button only controls the box 285, the box 285 now displays the second historical image “2” 220. Now, the first historical image “1” 210 is displayed in display unit 110 and the second historical image “2” 220 is displayed in display unit 120.

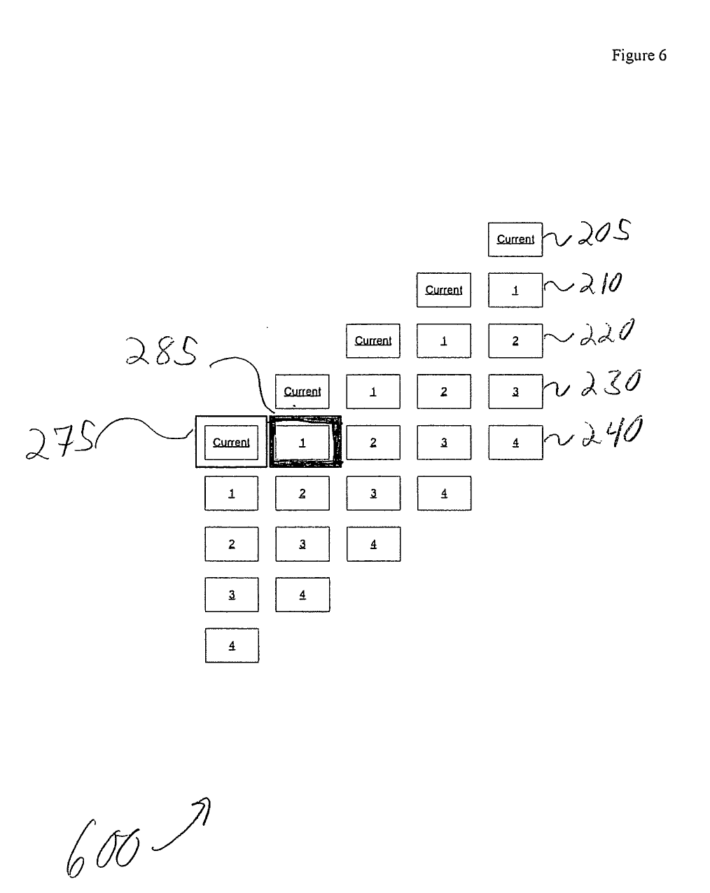

In FIG. 6, a user having the images displayed on units 110 and 120 of FIG. 5 as the current exam on display unit 110 and the second historical exam on display unit 120 has pressed the “left” arrow key on the keyboard. Notice that as the “right” and “left” arrow keys control both box 275 and 285, both box 275 and box 285 have shifted to the left. Pressing the “left” arrow key shifts the data sets to display the next most recent, or next least historical data sets, in time. As the “right” and “left” arrow keys control both the boxes 275 and 285, box 275 now displays a current data set 205 and box 285 displays a first historical image “1” 210. Now, the current data set 205 is displayed in display unit 110 and the first historical image “1” 210 is displayed in display unit 120.

In the above described systems, a user may easily navigate a plurality of data sets in a dynamic fashion. A user may efficiently use the arrow keys of the keyboard, or some other input device, to display and compare time-based information. Any combination of data sets may be displayed. For example, a current exam may be displayed with any historical exam and any historical exam with other historical exams. Moreover, any number of data sets may be utilized, permitting a user to more easily navigate large amounts of data.

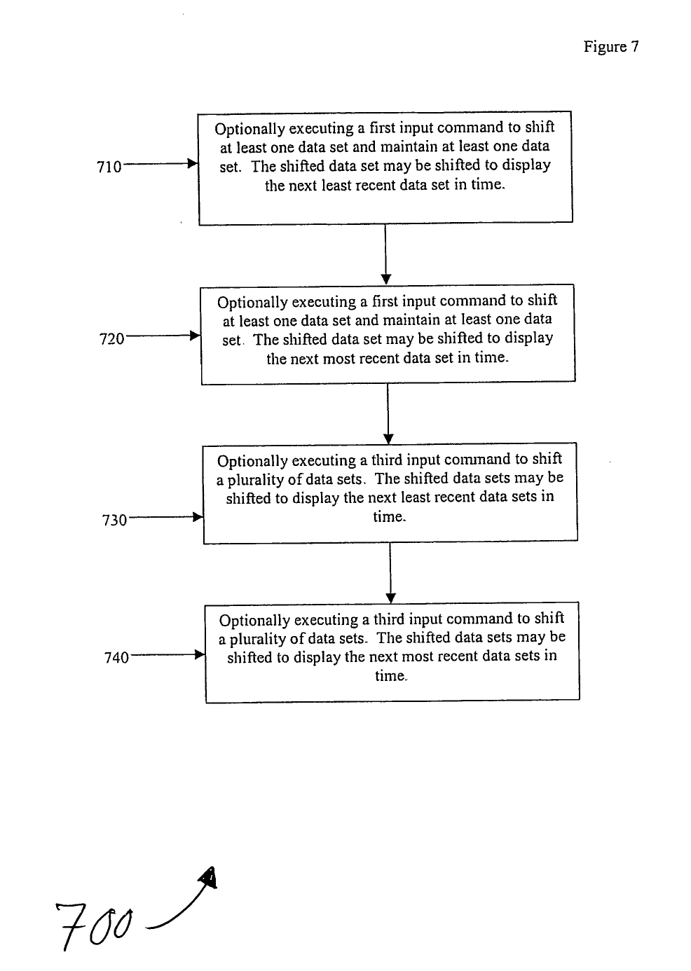

FIG. 7 illustrates a method 700 for dynamically comparing time-based information. As noted in the steps, the steps 710-740 are optional and may be executed in any order. At step 710 a user may optionally execute a first input command. The first input command may shift at least one data set and maintain at least one data set. The shifted data set may be shifted to display the next least recent data set in time. For example, the first input command may be executed by pressing the down arrow on the computer keyboard. At step 720, a user may optionally execute a second input command. The second input command may shift at least one data set and maintain at least one data set. The shifted data set may be shifted to display the next most recent data set in time. For example, the second input command may be executed by pressing the up arrow on the computer keyboard.

At step 730, a user may optionally execute a third input command. The third input command may shift a plurality of data sets. In an embodiment, the third input command may shift all of the available data sets. The shifted data sets may be shifted to display the next least recent data sets in time. For example the third input command may be executed by pressing the right arrow key on the computer keyboard. At step 740, a user may optionally execute a fourth input command. The fourth input command may shift a plurality of data sets. In an embodiment, the fourth input command may shift all of the available data sets. The shifted data sets may be shifted to display the next most recent data sets in time. For example the fourth input command may be executed by pressing the left arrow key on the computer keyboard.

The system and method described above may be carried out as part of a computer-readable storage medium including a set of instructions for a computer. The set of instructions may include a first optional input routine for optionally executing a first input command. The first input command may shift at least one data set and maintain at least one data set. The shifted data set may be shifted to display the next least recent data set in time. For example, the first optional input routine may be executed by pressing the down arrow on the computer keyboard. The set of instructions also includes a second optional input routine for optionally executing a second input command. The second input command may shift at least one data set and maintain at least one data set. The shifted data set may be shifted to display the next most recent data set in time. For example, the second optional input routine may be executed by pressing the up arrow on the computer keyboard.

The set of instructions may also include a third optional input routine for optionally executing a third optional input command. The third optional input command may shift a plurality of data sets. In an embodiment, the third input command may shift all of the available data sets. The shifted data sets may be shifted to display the next least recent data sets in time. For example the third input command may be executed by pressing the right arrow key on the computer keyboard. The set of instructions may also include a fourth optional input routine for optionally executing a fourth optional input command. The fourth optional input command may shift a plurality of data sets. In an embodiment, the fourth input command may shift all of the available data sets. The shifted data sets may be shifted to display the next most recent data sets in time. For example the fourth input command may be executed by pressing the left arrow key on the computer keyboard.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims

1. A system for dynamically comparing time-based information, said system comprising:
a computer unit for manipulating data and receiving input from a user, said computer unit executing computer software for a dynamic display protocol for controlling the display of a plurality of data sets; and
at least one display unit having a plurality of display regions for displaying said data sets.

2. The system of claim 1, wherein said dynamic display protocol includes a first input sequence, said first input sequence being a binary sequence to maintain the data set displayed on at least one first predetermined display region and shift the data set displayed on at least one second predetermined display region.

3. The system of claim 2, wherein said computer unit receives input from a user controlling the first input sequence from a computer keyboard.

4. The system of claim 3, wherein said user controls said first input sequence using the up and down arrow keys on said computer keyboard.

5. The system of claim 2, wherein after the execution of said first input sequence, said data set displayed on at least one first predetermined display region is maintained and the data set displayed on at least one second predetermined display region is either the next least recent data set in time or the next most recent data set in time, depending on the binary command issued by the user.

6. The system of claim 1, wherein said dynamic display protocol includes a second input sequence, said second input sequence being a binary sequence to shift the data set displayed on a plurality of display regions.

7. The system of claim 6, wherein said computer unit receives input from a user controlling the second input sequence from a computer keyboard.

8. The system of claim 7, wherein said user controls said second input sequence using the left and right arrow keys on said computer keyboard.

9. The system of claim 6, wherein after the execution of said second input sequence, said data sets displayed on said plurality of display regions are either the next least recent data set in time or the next most recent data set in time, depending on the binary command issued by a user.

10. The system of claim 1, wherein said data sets depict medical images.

11. The system of claim 1, wherein said computer unit receives input from a user controlling a computer mouse.

12. The system of claim 1, wherein said computer unit receives input from a user controlling a track ball.

13. A method for dynamically comparing time-based information, said method comprising:
optionally executing a first input command for shifting at least one data set displayed and maintaining at least one data set displayed, said shifted data set displayed being shifted to the next least recent data set in time;
optionally executing a second input command for shifting at least one data set displayed and maintaining at least one data set displayed, said shifted data set displayed being shifted to the next most recent data set in time;
optionally executing a third input command for shifting a plurality of data sets displayed, said plurality of shifted data sets displayed being shifted to the next least recent data sets in time; and
optionally executing a fourth input command for shifting a plurality of data sets displayed, said plurality of shifted data sets displayed being shifted to the next most recent data sets in time.

14. The method of claim 13, wherein said steps of optionally executing a first, second, third, or fourth input command are executed on a computer keyboard.

15. The method of claim 14, wherein said first input command may be executed by pressing the down arrow on the computer keyboard, said second input command may be executed by pressing the up arrow on the computer keyboard, said third input command may be executed by pressing the right arrow on the computer keyboard, and the fourth input command may be executed by pressing the left arrow on the computer keyboard.

16. The method of claim 13, wherein said data sets depict medical images.

17. A computer-readable storage medium including a set of instructions for a computer, the set of instructions comprising:
a first optional input routine for optionally executing a first input command for shifting at least one data set displayed and maintaining at least one data set displayed, said shifted data set displayed being shifted to the next least recent data set in time;
a second optional input routine for optionally executing a second input command for shifting at least one data set displayed and maintaining at least one data set displayed, said shifted data set displayed being shifted to the next most recent data set in time;
a third optional input routine for optionally executing a third input command for shifting a plurality of data sets displayed, said plurality of shifted data sets displayed being shifted to the next least recent data sets in time; and
a fourth optional input routine for optionally executing a fourth input command for shifting a plurality of data sets displayed, said plurality of shifted data sets displayed being shifted to the next most recent data sets in time.

18. The set of instructions of claim 17, wherein said first, second, third, or fourth optional input routine are executed on a computer keyboard.

19. The set of instructions of claim 18, wherein said first optional input routine may be executed by pressing the down arrow on the computer keyboard, said second optional input routine may be executed by pressing the up arrow on the computer keyboard, said third optional input routine may be executed by pressing the right arrow on the computer keyboard, and the fourth optional input routine may be executed by pressing the left arrow on the computer keyboard.

20. The set of instructions of claim 17, wherein said data sets depict medical images.

21. A system for comparing medical images, said system comprising:
a computer unit for manipulating data and receiving input from a user, said computer unit executing computer software for simultaneously displaying a plurality of images of a patient, said images being from different exams.

22. The system of claim 21, wherein said exams are performed at different periods of time.

23. The system of claim 21, wherein said images are images of substantially the same objects.

24. The system of claim 23, wherein said images are taken at different periods of time.

25. The system of claim 24, wherein said images are displayed as superimposed images.

26. The system of claim 25, wherein after receiving input from a user, a first image displayed on at least one first display layer is maintained and a second image displayed on at least one second display layer is either the next least recent image in time or the next most recent image in time, depending on the input from the user.

27. The system of claim 25, wherein said input from a user maintains a first image displayed on at least one first display layer and chronologically shifts a second image displayed on at least one second display layer.

28. The system of claim 21, further including a display unit for displaying said images.

29. The system of claim 25, wherein said input from a user shifts said display of said displayed images chronologically in time.

30. The system of claim 21, wherein said system is a PACS system.

31. A method for comparing medical images, said method comprising:
optionally executing a first input command for shifting at least one displayed image and maintaining at least one displayed image, said shifted displayed image being shifted to the next least recent data set in time;
optionally executing a second input command for shifting at least one displayed image and maintaining at least one displayed image, said shifted displayed image being shifted to the next most recent data set in time;
optionally executing a third input command for shifting a plurality of displayed images, said plurality of displayed images being shifted to the next least recent images in time; and
optionally executing a fourth input command for shifting a plurality of displayed images, said plurality of displayed images being shifted to the next most recent images in time.

32. The method of claim 31, wherein said images are images of substantially the same objects.

33. The method of claim 31, wherein said images are taken at different periods of time.

34. The method of claim 33, wherein said images are displayed as superimposed images.

35. The method of claim 31, wherein said method is executed as part of a PACS unit.
